(19) United States
(12) Patent Application Publication
(10) Pub. No.: US 2022/0360208 A1
(43) Pub. Date: Nov. 10, 2022

(54) MOTOR UNIT

(71) Applicant: Global Mixed-mode Technology Inc., Hsin-Chu (TW)

(72) Inventor: Chien-Lun Chu, Hsinchu County (TW)

(21) Appl. No.: 17/313,019

(22) Filed: May 6, 2021

(51) Int. Cl. H02P 29/024; H02P 29/028; H02P 29/032

(52) U.S. Cl. CPC H02P 29/0241; H02P 29/028; H02P 29/032

(57) ABSTRACT

A motor unit comprises a power supply, a diode, a capacitor, and a motor controller, where the motor controller comprises a switch unit and a control unit. The switch circuit includes a first upper-side switch, a first lower-side switch, a second upper-side switch, and a second lower-side switch. The control unit is configured to turn on the first upper-side switch and the second lower-side switch and turn off the first lower-side switch and the second upper-side switch. When an input voltage is less than a first reference voltage, the control unit is configured to turn off the first upper-side switch and the second lower-side switch. The motor controller may be configured to avoid an overvoltage problem.

### BACKGROUND OF THE INVENTION

### 1. Field of the Invention

The present invention relates to a motor unit, and more particularly, to a motor unit which is capable of avoiding an overvoltage problem.

### 2. Description of the Prior Art

FIG. 1 is a schematic diagram showing a conventional motor unit 10. The motor unit 10 comprises a power supply 130, a diode D, a capacitor C, and a motor controller 100. The motor controller 100 is used for driving a motor, where the motor has a motor coil L. The motor coil L has a first terminal O1 and a second terminal O2. The motor controller 10 comprises a switch circuit 110 and a control unit 120. The switch circuit 110 includes a transistor 101, a transistor 102, a transistor 103, and a transistor 104 for supplying a coil current IL to the motor coil L. The control unit 120 generates a first control signal C1, a second control signal C2, a third control signal C3, and a fourth control signal C4 so as to respectively control the ON/OFF states of the transistor 101, the transistor 102, the transistor 103, and the transistor 104.

The power supply 130 provides an input voltage VIN to the motor controller 100 via the diode D. When the power supply 130 stops providing the power and the input voltage VIN is less than a specific voltage, the motor controller 100 turns off the switch circuit 110. At this moment the motor coil L still has the remaining current, thereby charging the capacitor C via a body diode of an upper-side transistor. It will result in an overvoltage problem.

### SUMMARY OF THE INVENTION

According to the present invention, a motor unit which is capable of avoiding an overvoltage problem is provided. The motor unit comprises a power supply, a diode, a capacitor, and a motor controller. The diode is coupled to the power supply, where the power supply provides an input voltage to the motor controller via the diode. The capacitor is coupled to the diode. The motor controller is used for driving a motor, where the motor has a motor coil. The motor controller comprises a switch circuit and a control unit. The switch circuit is configured to supply a coil current to the motor coil, where the switch circuit includes a first upper-side switch, a first lower-side switch, a second upper-side switch, and a second lower-side switch. The control unit generates a plurality of control signals to control the switch circuit, where the control unit is configured to turn on the first upper-side switch and the second lower-side switch and turn off the first lower-side switch and the second upper-side switch. When the input voltage is less than a first reference voltage, the control unit is configured to turn off the first upper-side switch, the first lower-side switch, the second upper-side switch, and the second lower-side switch. At this moment the current flows sequentially to the first lower-side switch, the motor coil, and the second upper-side switch, such that the remaining current charges the capacitor and enables the input voltage to increase. The first reference voltage may be an undervoltage lockout voltage. When the input voltage is greater than the first reference voltage again, the control unit is configured to turn on the first upper-side switch and the second lower-side switch and turn off the first lower-side switch and the second upper-side switch. Thus, the motor controller may have enough time to discharge the remaining current. The motor controller enables the input voltage to oscillate nearby the first reference voltage.

When the input voltage is less than a second reference voltage, the control unit is configured to turn off the first upper-side switch, the first lower-side switch, the second upper-side switch, and the second lower-side switch. The second reference voltage may be a power on reset voltage and the first reference voltage is greater than the second reference voltage. The motor controller may be implemented in an integrated circuit chip. When the input voltage is less than the second reference voltage, the integrated circuit chip may be reset. Furthermore, when the input voltage is less than the second reference voltage, the motor controller may reset a memory unit. According to one embodiment of the present invention, when the input voltage is less than the second reference voltage, the motor controller does not result in a braking feeling upon the motor. Both the motor unit and the motor controller may be applied to a single-phase or polyphase configuration. The motor controller may be configured to avoid an overvoltage problem.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram showing a conventional motor unit;

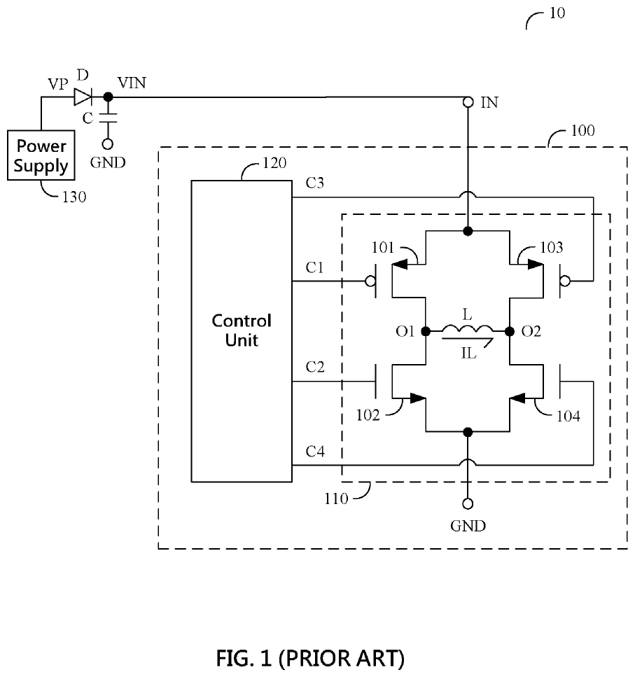

FIG. 2 is a schematic diagram showing a motor unit according to one embodiment of the present invention; and

FIG. 3 is a timing chart according to one embodiment of the present invention.

### DETAILED DESCRIPTION

Preferred embodiments according to the present invention will be described in detail with reference to the drawings.

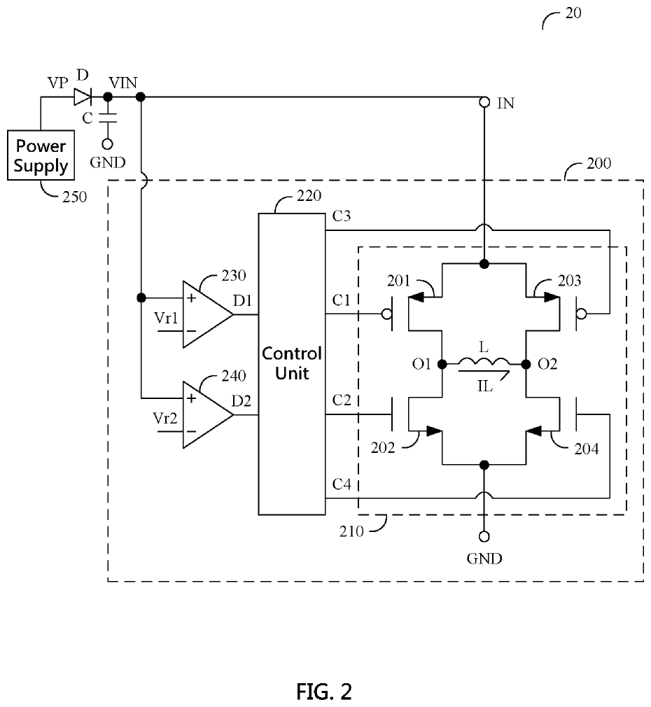

FIG. 2 is a schematic diagram showing a motor unit 20 according to one embodiment of the present invention. The motor unit 20 comprises a power supply 250, a diode D, a capacitor C, and a motor controller 200. The motor controller 200 is used for driving a motor, where the motor has a motor coil L. The motor coil L has a first terminal O1 and a second terminal O2. The motor controller 20 comprises a switch circuit 210, a control unit 220, a first comparator 230, and a second comparator 240. The switch circuit 210 includes a first transistor 201, a second transistor 202, a third transistor 203, and a fourth transistor 204 for supplying a coil current IL to the motor coil L. The first transistor 201 is coupled to an input terminal IN and the first terminal O1 while the second transistor 202 is coupled to the first terminal O1 and a third terminal GND. The third transistor 203 is coupled to the input terminal IN and the second terminal O2 while the fourth transistor 204 is coupled to the second terminal O2 and the third terminal GND. Each of the first transistor 201, the second transistor 202, the third transistor 203, and the fourth transistor 204 may be respectively a p-type MOSFET or an n-type MOSFET. As shown in FIG. 2, each of the first transistor 201 and the third transistor 203 may be a p-type MOSFET, while each of the second transistor 202 and the fourth transistor 204 may be an n-type MOSFET. Furthermore, the switch circuit 210 is an H-bridge circuit. The first transistor 201 may be a first upper-side switch. The second transistor 202 may be a first lower-side switch. The third transistor 203 may be a second upper-side switch. The fourth transistor 204 may be a second lower-side switch.

The control unit 220 generates a first control signal C1, a second control signal C2, a third control signal C3, and a fourth control signal C4 so as to respectively control the ON/OFF states of the first transistor 201, the second transistor 202, the third transistor 203, and the fourth transistor 204. The power supply 250 is coupled to one terminal of the diode D and generates a power voltage VP to the diode D. Another terminal of the diode D is coupled to one terminal of the capacitor C and the input terminal IN. The diode D may be used for preventing a reverse current generated by the motor controller 200 from flowing back to the power supply 250. Another terminal of the capacitor C is coupled to the third terminal GND. The power supply 250 provides an input voltage VIN to the motor controller 200 via the diode D, such that the motor controller 200 can operate normally. The first comparator 230 compares the input voltage VIN with a first reference voltage Vr1, so as to generate a first driving signal D1 to the control unit 220. The second comparator 240 compares the input voltage VIN with a second reference voltage Vr2, so as to generate a second driving signal D2 to the control unit 220. The first reference voltage Vr1 is greater than the second reference voltage Vr2.

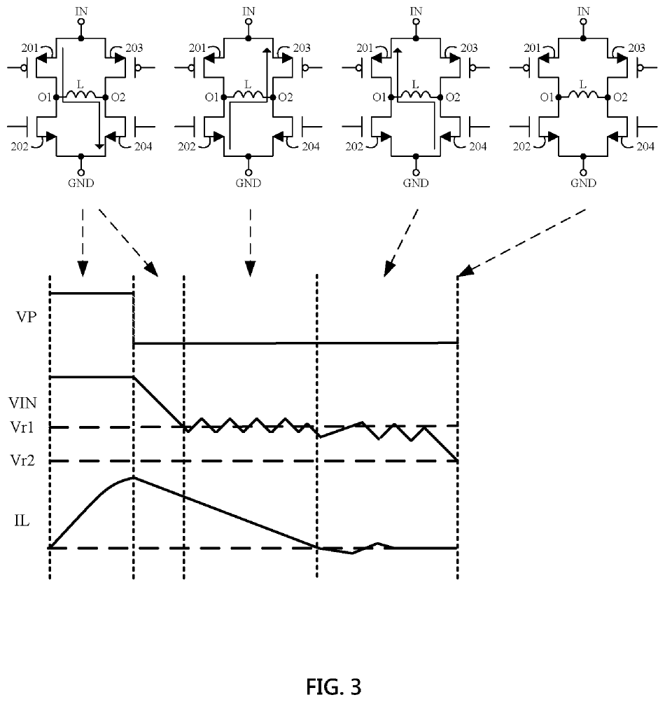

FIG. 3 is a timing chart according to one embodiment of the present invention. By controlling the first control signal C1, the second control signal C2, the third control signal C3, and the fourth control signal C4, the control unit 220 is configured to turn on the first transistor 201 and the fourth transistor 204 and turn off the second transistor 203 and the third transistor 203. At this moment the current flows sequentially from the input terminal IN to the first transistor 201, the motor coil L, and the fourth transistor 204 for supplying the energy to the motor. When the power supply 250 stops providing the power, the power voltage VP decreases to 0 immediately and the input voltage VIN starts to decrease. When the input voltage VIN is less than the first reference voltage Vr1, the first comparator 230 enables the first driving signal D1 to be a low level. By controlling the first control signal C1, the second control signal C2, the third control signal C3, and the fourth control signal C4, the control unit 220 is configured to turn off the first transistor 201, the second transistor 202, the third transistor 203, and the fourth transistor 204. At this moment the current flows sequentially to the second transistor 202, the motor coil L, and the third transistor 203, such that the remaining current charges the capacitor C and enables the input voltage VIN to increase. When the input voltage VIN is greater than the first reference voltage Vr1 again, the first comparator 230 enables the first driving signal D1 to be a high level. By controlling the first control signal C1, the second control signal C2, the third control signal C3, and the fourth control signal C4, the control unit 220 is configured to turn on the first transistor 201 and the fourth transistor 204 and turn off the second transistor 203 and the third transistor 203. Therefore, according to one embodiment of the present invention, the motor controller 200 may have enough time to discharge the remaining current. As shown in FIG. 3, the motor controller 200 enables the input voltage VIN to oscillate nearby the first reference voltage Vr1. For example, the first reference voltage Vr1 may be an undervoltage lockout voltage. The motor controller 200 may be implemented in an integrated circuit chip.

When the input voltage VIN is less than the second reference voltage Vr2, the second comparator 240 enables the second driving signal D2 to be the low level, where the second reference voltage may be a power on reset voltage. By controlling the first control signal C1, the second control signal C2, the third control signal C3, and the fourth control signal C4, the control unit 220 is configured to turn off the first transistor 201, the second transistor 202, the third transistor 203, and the fourth transistor 204. At this moment the remaining current of the motor coil L is released completely and thus there is no overvoltage problem when the integrated circuit chip is reset. That is to say, the motor controller 200 may reset a memory unit. According to one embodiment of the present invention, when the input voltage VIN is less than the second reference voltage Vr2, the motor controller 200 does not result in a braking feeling upon the motor. Both the motor unit 20 and the motor controller 200 may be applied to a single-phase or polyphase configuration. The motor controller 200 may be configured to avoid an overvoltage problem.

While the present invention has been described by the preferred embodiment, it is to be understood that the invention is not limited to the disclosed embodiment. On the contrary, it is intended to cover various modifications. Therefore, the scope of the appended claims should be accorded the broadest interpretation so as to encompass all such modifications.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motor unit comprising:
a power supply;
a motor controller, comprising a switch circuit and a control unit, wherein the switch circuit comprises a first upper-side switch, a first lower-side switch, a second upper-side switch, and a second lower-side switch;
a diode, coupled to the power supply, wherein the power supply provides an input voltage to the motor controller via the diode; and
a capacitor, coupled to the diode, wherein the control unit is configured to turn on the first upper-side switch and the second lower-side switch and turn off the first lower-side switch and the second upper-side switch, and when the input voltage is less than a first reference voltage, the control unit is configured to turn off the first upper-side switch and the second lower-side switch.

2. The motor unit of claim 1, wherein when the input voltage is less than the first reference voltage, the control unit is further configured to turn off the first lower-side switch and the second upper-side switch.

3. The motor unit of claim 1, wherein the first reference voltage is an undervoltage lockout voltage.

4. The motor unit of claim 1, wherein when the input voltage is greater than the first reference voltage again, the control unit is configured to turn on the first upper-side switch and the second lower-side switch and turn off the first lower-side switch and the second upper-side switch.

5. The motor unit of claim 1, wherein the motor controller enables the input voltage to oscillate nearby the first reference voltage.

6. The motor unit of claim 1, wherein when the input voltage is less than a second reference voltage, the control unit is configured to turn off the first upper-side switch, the first lower-side switch, the second upper-side switch, and the second lower-side switch.

7. The motor unit of claim 6, wherein the second reference voltage is a power on reset voltage.

8. The motor unit of claim 6, wherein the first reference voltage is greater than the second reference voltage.

9. The motor unit of claim 1, wherein when the input voltage is less than a second reference voltage, the motor controller resets a memory unit.

10. The motor unit of claim 1, wherein the motor controller is implemented in an integrated circuit chip, and when the input voltage is less than a second reference voltage, the integrated circuit chip is reset.

11. The motor unit of claim 1, wherein the motor unit is applied to a single-phase or polyphase configuration.

12. The motor unit of claim 1, wherein the motor controller is configured to avoid an overvoltage problem.

13. A motor controller, wherein the motor controller is configured to drive a motor, the motor has a motor coil, and the motor controller comprising:
a switch circuit, configured to supply a coil current to the motor coil, wherein the switch circuit comprises a first upper-side switch, a first lower-side switch, a second upper-side switch, and a second lower-side switch; and
a control unit, configured to generate a plurality of control signals to control the switch circuit, wherein the control unit is configured to turn on the first upper-side switch and the second lower-side switch and turn off the first lower-side switch and the second upper-side switch, and when an input voltage is less than a first reference voltage, the control unit is configured to turn off the first upper-side switch and the second lower-side switch.

14. The motor controller of claim 13, wherein when the input voltage is less than the first reference voltage, the control unit is further configured to turn off the first lower-side switch and the second upper-side switch.

15. The motor controller of claim 13, wherein the first reference voltage is an undervoltage lockout voltage.

16. The motor controller of claim 13, wherein when the input voltage is greater than the first reference voltage again, the control unit is configured to turn on the first upper-side switch and the second lower-side switch and turn off the first lower-side switch and the second upper-side switch.

17. The motor controller of claim 13, wherein the motor controller enables the input voltage to oscillate nearby the first reference voltage.

18. The motor controller of claim 13, wherein when the input voltage is less than a second reference voltage, the control unit is configured to turn off the first upper-side switch, the first lower-side switch, the second upper-side switch, and the second lower-side switch.

19. The motor controller of claim 18, wherein the second reference voltage is a power on reset voltage.

20. The motor controller of claim 18, wherein the first reference voltage is greater than the second reference voltage.

21. The motor controller of claim 13, wherein the motor controller further comprises a first comparator and a second comparator, the first comparator compares the input voltage with the first reference voltage, so as to generate a first driving signal to the control unit, and the second comparator compares the input voltage with a second reference voltage, so as to generate a second driving signal to the control unit.

22. The motor controller of claim 13, wherein when the input voltage is less than a second reference voltage, the motor controller resets a memory unit.

23. The motor controller of claim 13, wherein the motor controller is implemented in an integrated circuit chip, and when the input voltage is less than a second reference voltage, the integrated circuit chip is reset.

24. The motor controller of claim 13, wherein the motor controller is applied to a single-phase or polyphase configuration.

25. The motor controller of claim 13, wherein the motor controller is configured to avoid an overvoltage problem.
